(19) United States
(12) Patent Application Publication
(10) Pub. No.: US 2001/0039763 A1
(43) Pub. Date: Nov. 15, 2001

(54) WINDOW SASH

(76) Inventor: TATSUYA MIYATA, MIHARA-SHI (JP)

Correspondence Address: ROGER R WISE, PILLSBURY MADISON & SUTRO LLP, 725 SOUTH FIGUEROA STREET, SUITE 2800, LOS ANGELES, CA, 90017-5406, US

(21) Appl. No.: 09/359,079

(22) Filed: Jul. 22, 1999

(51) Int. Cl. E06B 3/00

(52) U.S. Cl. 49/413; 49/452

(57) ABSTRACT

The window sash allows window glasses to be fitted to and removed from the window sash without removing the window sash, so that the fitting and removing work of the window glass is simplified. In the lower stage of an outer rail (31) and an inner rail (32) of a lower frame (3), is removably inserted a spacer (6) which is made of an elastically deformable hard resin material or the like and which has a generally trapezoidal, uniform cross-sectional shape with its top face (6a) larger in width than its bottom face (6b). The top face (6a) of the spacer (6) forms the bottom face of upper stages of an outer rail (31) and an inner rail (32). By once removing the spacer (6) inserted in the rails (31, 32) of the lower frame (3), window glasses (4, 5) are made movable upward and downward in the window sash (1), so that the replacing work of the window glasses (4, 5) for the window sash (1) can be very easily achieved without the need of deforming the upper frame (2) and the lower frame (3), while the window sash (1) remains attached to the vehicle body.

### BACKGROUND OF THE INVENTION

The present invention relates to a window sash which is attached to a wall surface of a house or a body surface of a vehicle, and to which a window glass that moves parallel to the glass surface is fitted.

As a window to be attached to a wall surface of a house or a body surface of a vehicle, there has been provided a window in which a window glass can be moved parallel to the glass surface within a window sash. A window sash applicable to such a window has, at least on each of two sides parallel to the opening/closing direction of the window glass, a rail formed of three faces facing front, rear and end faces of the window glass, respectively. For example, when the window glass moves horizontally within the window sash, upper and lower end portions of the window glass fit into the rails of upper and lower frames of the window sash, and the window glass moves in a direction defined by two faces of each rail opposite to the front and rear faces of the window glass, out of the three faces forming each of the rails of the upper and lower frames.

Among such window sashes, there has been available a window sash in which, in the two rails parallel to the opening/closing direction of the window glass, the distance between faces of the two rails facing the end faces of the window glass is longer than a length of the window glass in a direction perpendicular to its moving direction with a view to facilitating the workability in fitting and removing the window glass. For example, in the case where the window glass moves horizontally within the window sash, the distance between the top face of the upper rail and the bottom face of the lower rail is set generally equal to a length obtained by adding up the vertical length of the window glass and the depth of the lower rail. As a result of this, when the upper end face of the window glass fitted into the window sash has come into contact with the top face of the upper rail, the lower end portion of the window glass is no longer engaged with the lower rail so that the window glass can be removed from the window sash by moving the lower end portion of the window glass in a direction perpendicular to the glass surface. Also, for fitting the window glass to the window sash, the upper end face of the window glass is brought into contact with the top face of the upper rail, and thereafter the lower end portion of the window glass is fitted into the lower rail.

However, if, in the two rails parallel to the opening/closing direction of the window glass, the distance of the faces of the rails opposite to the end faces of the window glass is set longer than the length of the window glass in the direction perpendicular to its moving direction, then there are some cases where moving the window glass along the rails in the opening/closing operation of the window glass may cause a force in rotational directions within the glass plane to act on the window glass due to a frictional resistance between one end face of the window glass and the inner surface of the rail, making the window glass inclined within the window sash so that one end portion of the window glass no longer fits to the rail of the window sash, and that the window glass becomes more likely to be disengaged from the window sash. In particular, because the window sash for use in a vehicle undergoes the effect of external force such as vibrations during the move of the vehicle body, there are some cases where end portions of the window glass come out of engagement with the rails parallel to the opening/closing direction even on occasions other than the opening/closing operation of the window glass, incurring a high risk that the window glass may fall off from the moving vehicle with the result of a serious accident.

Thus, among conventional window sashes is a window sash in which the distance between rails formed at two frames parallel to the opening/closing direction, respectively, is set generally equal to the vertical length of the window glass so that the window glass is prevented from falling off from the window sash even when some force in rotational directions has acted on the window glass during the opening/closing operation of the window glass or when vibrations or the like have acted on the window sash. In such a window sash, while the distance between the two frames of the window sash parallel to the opening/closing direction of the window glass is increased by elastically deforming either one or both of the two frames, the window glass is fitted to and removed from the window sash.

However, for the window sash in which the distance between the rails formed at the two frames parallel to the opening/closing direction, because the frames need to be elastically deformed in the fitting/removing operation of the window glass, the window sash has to be once removed from the wall surface of a house or the body of a vehicle in the fitting/removing operation of the window glass. This has been a cause of the problem that the work of replacing the window glass becomes more complex.

In particular, in window sashes for use in a vehicle, there is a tendency, in response to the demand for flush surfaces of the vehicle body, that the conventional method of removably fitting the window sash to a window-use opening portion of the vehicle body by means of fitting rubber is replaced by a method of bonding the window sash to the window-use opening portion of the vehicle body by means of an adhesive. In this case, however, there arises a need of removing the adhesive to remove the window sash from the vehicle body, which would lead to a problem that the work of replacing the window glass or the like becomes more complex. This problem very largely matters for window sashes to be used in working vehicles which are liable to damage of the window glass and high in replacement frequency of the window glass.

An object of the present invention is therefore to provide a window sash which allows the window glass to be fitted to and removed from the wall surface of a house or the body of a vehicle without removing the window sash therefrom, and which allows the fitting/removing work of the window glass to be simplified.

To achieve the above object, in a first aspect of the present invention, there is provided a window sash characterized by comprising: a quadrilateral frame in which rails are formed at two sides parallel to each other; two window glasses which move along the rails within the frame; and a spacer which is removably fitted into between at least one end face of each window glass out of its two end faces parallel to each other, and an inner surface of one of the rails facing the end face.

According to this invention, the spacer is removably located between at least one end face of the window glass and the inner surface of the rail facing this end face. Therefore, when the spacer is removed from between the end face of the window glass and the inner surface of the rail, the movable range of the window glass within the frame along a direction perpendicular to the moving direction is increased so that the workability for the fitting/removal work of the window glass to and from the frame can be improved. On the other hand, when the spacer is inserted into between the end face of the window glass and the inner surface of the rail, the movable range of the window glass within the frame along the direction perpendicular to the rail is decreased so that the window glass becomes unlikely to fall off from the frame in the opening/closing operation of the window glass or upon the action of any external force such as vibrations.

In an embodiment of the present invention, the window sash is characterized in that the spacer is composed of a plurality of portions divided along a longitudinal direction of the rails.

According to this embodiment, the spacer plurally divided along a longitudinal direction of the rails is located between the end face of the window glass and the inner surface of the rail facing this end face. Therefore, the ratio of the spacer occupying in the part facing the end face of the window glass is decreased so that the fitting and removing of the spacer can be achieved more easily.

In an embodiment of the present invention, the window sash is characterized in that, with respect to each of the rails formed at two sides of the frame parallel to each other, a distance between faces of the rail facing an end face of each window glass is generally equal to a sum of a distance between the two end faces of the window glass parallel to each other and a height of the spacer.

According to this embodiment, the distance between faces of the two rails facing an end face of each window glass is generally equal to the sum of the length of the window glass and the height of the spacer. Therefore, when the spacer is inserted into between the end face of the window glass and the inner surface of the rail, any move of the window glass in the frame along a direction perpendicular to the moving direction is securely restricted so that the window glass is securely prevented from falling off from the frames in the opening/closing operation of the window glass or upon the action of any external force such as vibrations. On the other hand, when the spacer is removed from between the end face of the window glass and the inner surface of the rail, the window glass becomes movable within the frame along the direction perpendicular to the moving direction so that the workability for fitting and removing the window glass to and from the frame is improved.

### BRIEF DESCRIPTION OF THE DRAWINGS

FIG. 1 is a front view of a window sash according to an embodiment of the present invention;

FIGS. 2A and 2B are views showing cross-sectional shapes of the upper frame and the lower frame constituting the window sash, respectively;

FIG. 3 is a view showing a cross section of a vicinity of the lower frame when the window sash is in use;

FIG. 4 is a view showing a divided state of the spacer applied to the window sash; and

FIGS. 5A to 5f are views for explaining the replacement work of the window glass in the window sash.

### DETAILED DESCRIPTION OF THE PREFERRED EMBODIMENTS

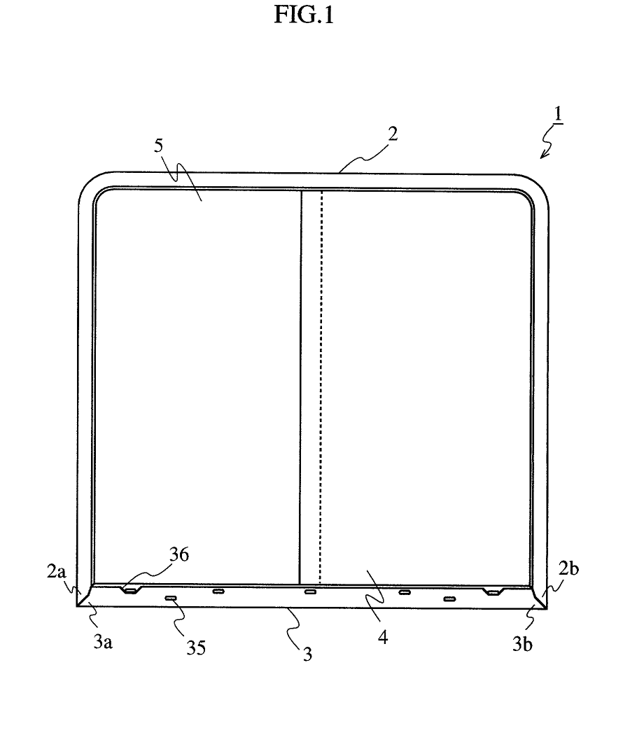

FIG. 1 is a front view of a window sash according to an embodiment of the present invention. The window sash 1 comprises a generally U-shaped upper frame 2 and a linear lower frame 3. The upper frame 2 and the lower frame 3 are molded into a generally uniform cross-sectional shape by drawing process from a material of, for example, an aluminum alloy, where open ends 2a and 2b of the upper frame 2 and both ends 3a and 3b of the lower frame 3 are fixed to each other, respectively, by brazing or the like to make up a window pane of a specified range. That is, the upper frame 2 bent at intermediate two places and thereby formed into a generally U-shape forms left side, top side and right side of the generally rectangular window pane, while the linear lower frame 3 forms the lower side of the generally rectangular window pane. In the window pane defined by the upper frame 2 and the lower frame 3, the window sash 1 holds two window glasses 4 and 5 movable parallel to the window pane.

In addition, the window glasses 4 and 5 have, at their respective inner side faces, unshown grips each equipped with a lock mechanism, and moving the window glasses 4 and 5 within the window sash 1 by holding these grips allows the window pane to be opened and closed. The lock mechanism provided to the grips elastically is engaged with an unshown receiver provided at a portion of the upper frame 2, and releasing the engaged state of the lock mechanism to the receiver allows the window glass to be moved.

Otherwise, the window sash 1 may be provided as a window sash that forms a window pane with any arbitrary formation having a single or plurality of joint portions. For example, the window sash may be so arranged that four linear frames are joined together at four places, or that both ends of one frame bent at four places are joined together at one place.

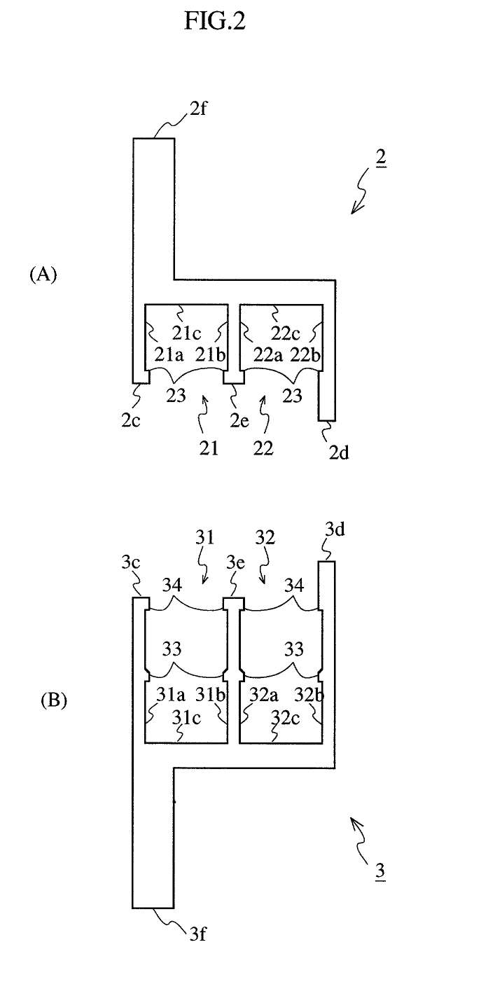

FIGS. 2A and 2B are views showing cross-sectional shapes of the upper frame and the lower frame constituting the window sash, respectively. On the inner peripheral surface of the upper frame 2, are formed an outer rail 21 and an inner rail 22 over the entire periphery. The outer rail 21 has a generally U-shaped cross section formed by mutually opposing two vertical surfaces 21a, 21b and one horizontal surface 21c. The inner rail 22 has a generally U-shaped cross section formed by mutually opposing two vertical surfaces 22a, 22b and one horizontal surface 22c. One vertical surface 21a forming part of the outer rail 21 is the inner surface of an outer wall 2c of the upper frame 2, and the other vertical surface 21b forming part of the outer rail 21 and one vertical surface 22a forming part of the inner rail 22 are the front and rear surfaces of an intermediate wall 2e of the upper frame 2. Also, the other vertical surface 22b forming part of the inner rail 22 is the inner surface of an inner wall 2d of the upper frame 2.

In addition, the inner wall 2d of the upper frame 2 is protruded on the inner 10 periphery side of the upper frame 2 more than the outer wall 2c and the intermediate wall 2e, taking into consideration watertightness from the outside of the window sash 1. Also, a fitting portion 2f is provided so as to extend over the entire periphery of the outer peripheral surface of the upper frame 2. By means of an adhesive applied to the inner surface of this fitting portion 2f, or fitting rubber into which the entire fitting portion 2f is fitted, the upper frame 2 is adhesively bonded, or fitted, to the periphery of the window-use opening portion of the vehicle body. Further, step portions 23 are formed at end portions of the vertical surfaces 21a, 21b, 22a, 22b, respectively, in the outer rail 21 and the inner rail 22 of the upper frame 2. A later-described glass channel 8 is engaged with these step portions 23.

An outer rail 31 and an inner rail 32 are formed over the entire length of the upper surface of the lower frame 3. The outer rail 31 has a generally U-shaped cross section formed by mutually opposing two vertical surfaces 31a, 31b and one horizontal surface 31c. The inner rail 32 has a generally U-shaped cross section formed by mutually opposing two vertical surfaces 32a, 32b and one horizontal surface 32c.

One vertical surface 31a forming part of the inner rail 32 is the inner surface of an outer wall 3c of the lower frame 3, and the other vertical surface 31b forming part of the outer rail 31 and one vertical surface 32a forming part of the inner rail 32 are the front and rear surfaces of an intermediate wall 3e of the lower frame 3. Also, the other vertical surface 32b forming part of the inner rail 32 is the inner surface of an inner wall 3d of the lower frame 3. Further, the outer rail 31 and the inner rail 32 are formed into two stages, respectively, by step portions 33 formed at vertically intermediate portions of the vertical surfaces 31a, 31b, 32a, 32b, respectively. Besides, step portions 34 are formed at end portions of the vertical surfaces 31a, 31b, 32a, 32b, respectively, in the outer rail 31 and the inner rail 32 of the lower frame 3. The later-described glass channel 8 is engaged with these step portions 34.

In addition, the inner wall 3d of the lower frame 3 is protruded on the upper surface side of the lower frame 3 more than the outer wall 3c and the intermediate wall 3e so that water having penetrated into the outer rail 31 and the inner rail 32 overflows outward of the lower frame 3. Also, a fitting portion 3f is provided so as to extend over the entire length of the lower surface of the lower frame 3. By means of an adhesive applied to the inner surface of this fitting portion 3f, or fitting rubber into which the entire fitting portion 3f is fitted, the lower frame 3 is adhesively bonded, or fitted, to the periphery of the window-use opening portion of the vehicle body. Further, a plurality of drain holes 35 and drain cutouts 36 are formed, as shown in FIG. 1, in the outer wall 3c of the lower frame 3.

When the window glasses 4, 5 are fitted to the window sash 1 made up of the upper frame 2 and the lower frame 3 showing the above-described cross-sectional shape, near-the-end portions of the right side and upper side of the outer window glass 4 fit into the outer rail 21 of the upper frame 2, and a near-the-end portion of the lower side of the outer window glass 4 fits into the outer rail 31 of the lower frame 3. Also, near-the-end portions of the left side and upper side of the inner window glass 5 fit into the inner rail 22 of the upper frame 2, and a near-the-end portion of the lower side of the inner window glass 5 fits into the inner rail 32 of the lower frame 3.

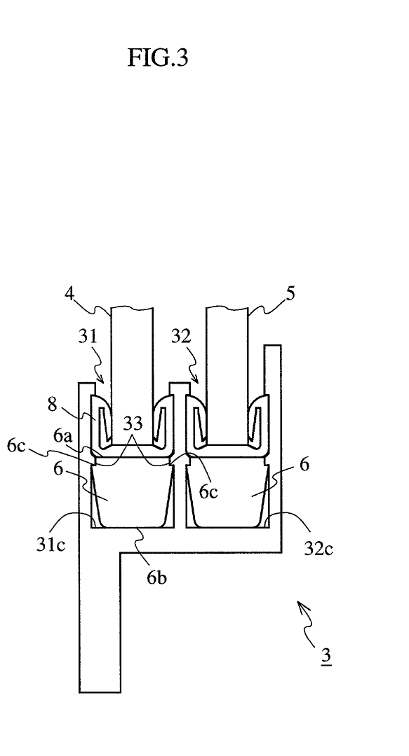

FIG. 3 is a view showing a cross section of a vicinity of the lower frame when the window sash is in use. Spacers 6 are removably inserted in the lower stage of the outer rail 31 and the lower stage of the inner rail 32 in the lower frame 3. Each spacer 6 is made of, for example, an elastically deformable hard resin material, and has a generally trapezoidal, uniform cross-sectional shape with its top face 6a larger in width than its bottom face 6b. With respect to this spacer 6, its height is generally equal to a length from the horizontal surfaces 31c and 32c of the outer rail 31 and the inner rail 32 of the lower frame 3 to the upper edge of the step portions 33, the width of the top face 6a is generally equal to the width of the outer rail 31 and the inner rail 32 of the lower frame 3, and the width of the bottom face 6b is shorter than the distance between the step portions 33 in each of the outer rail 31 and the inner rail 32. Also, recessed portions 6c are formed at corner portions of the top sides 6a so as to engage with the step portions 33, respectively.

Therefore, when the spacers 6 are inserted in the lower stages of the outer rail 31 and the inner rail 32, the bottom faces 6b of the spacers 6 come into contact with the horizontal surfaces 31c and 32c of the outer rail 31 and the inner rail 32, with the step portions 33 engaged with the recessed portions 6c, in which state the top faces 6a of the spacers 6 form the bottom faces of upper stages of the outer rail 31 and the inner rail 32, respectively.

In addition, because the width of the bottom face 6b of each spacer 6 is set shorter than the distance between the step portions 33 in the outer rail 31 or the inner rail 32 and because the width of the top face 6a of each spacer 6 is set generally equal to the width of the outer rail 31 or the inner rail 32 as described above, an intermediate portion of an inclined surface of the spacer 6 comes into contact with the step portion 33 in the process of inserting the spacer 6 into the lower stage of the outer rail 31 or the inner rail 32. Upon pressing the spacer 6 downward in this state, the spacer 6 is elastically deformed, moving to a state that the spacer 6 is located within the lower stage of the outer rail 31 or the inner rail 32.

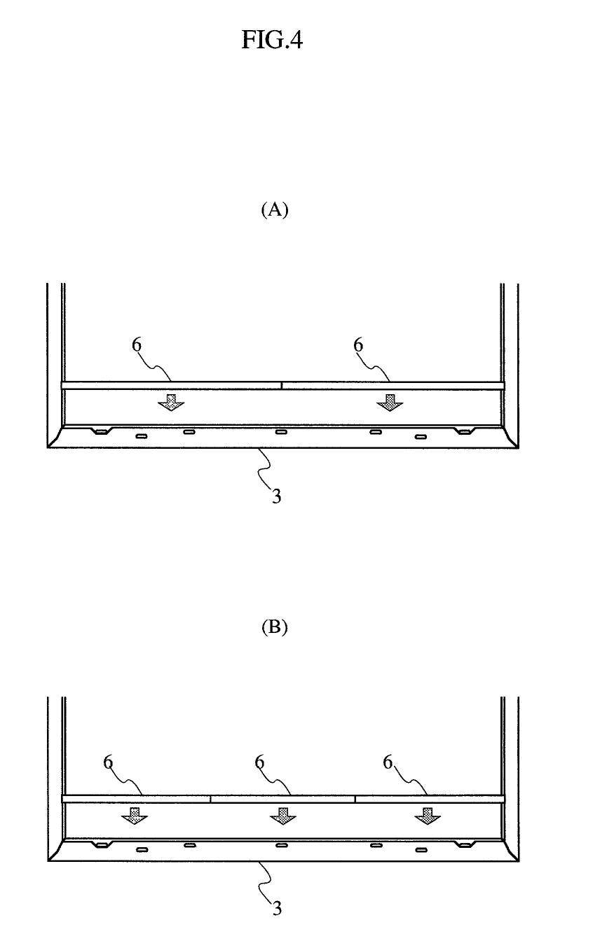

Also, each spacer 6 has a height generally equal to the depth of the outer rail 21 or the inner rail 22 of the upper frame 2 as well as the depth of a portion of the lower frame 3 ranging up to the outer rail 31 or the inner rail 32. Further, taking into consideration that the window glasses 4, 5 move along the lower frame 3, the spacer 6 needs to be located in the lower stage of the outer rail 31 or the inner rail 32 over the generally entire length of the lower frame 3, but it is not necessarily required that the length of one spacer 6 be set generally equal to the entire length of the lower frame 3. That is, as shown in FIG. 4A or 4B as an example, two or three spacers 6 plurally divided along the longitudinal direction of the lower frame 3 may be inserted over the entire length of the lower frame 3. In addition, the number of divisions of the spacer 6 is not limited to 2 or 3.

By plurally dividing the spacer 6 along the longitudinal direction of the lower frame 3 like this, the ratio of a portion of each spacer 6 facing the bottom faces of the window glasses 4, 5 is decreased, facilitating the fitting/removing work of the spacers 6 to and from the lower frame 3.

Meanwhile, a glass channel 8 is removably fitted in each of the outer rails 21, 31 and the inner rails 22, 32 in the upper frame 2 and the lower frame 3 constituting the window sash 1, generally all around. This glass channel 8 is made of an elastically deformable soft resin material such as rubber, and its portions to make contact with the front and rear surfaces and end surface of the window glasses 4, 5 have been subjected to gigging process. Therefore, the two window glasses 4, 5 move within the glass channel 8. This glass channel 8 reduces frictional resistance during the move of the window glasses 4, 5 to smooth their move, ensures airtightness and watertightness between outside and inside of the window pane defined by the window sash 1, and further relaxes the propagation of vibrations from the window sash 1 to the window glasses 4, 5.

In the window sash 1, the distance between the horizontal surfaces 21c and 22c of the outer rail 21 and the inner rail 22 of the upper frame 2, and the horizontal surfaces 31c and 32c of the outer rail 31 and the inner rail 32 of the lower frame 3 is set generally equal to the sum of the vertical length of the window glass 4, 5, the vertical thickness of the glass channel 8 and the height of the spacer 6. Therefore, in the state that the spacer 6 is inserted in the lower frame 3, there is almost no gap that allows the window glasses 4, 5 to move vertically in the window sash 1, so that the window glasses 4, 5 are securely held fitted in the rails 21, 22 formed at the upper side of the upper frame 2 and in the rails 31, 32 formed in the lower frame 3. As a result of this, the window glasses 4, 5 can be securely prevented from falling off from the window sash 1.

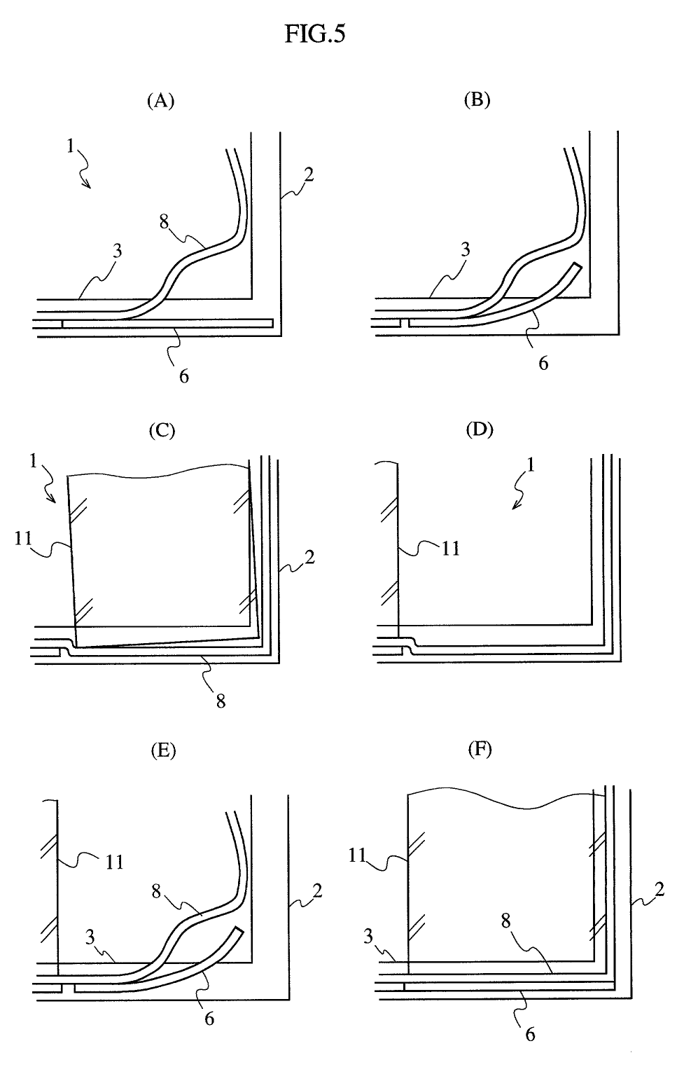

FIGS. 5A to 5F are views for explaining the replacement work of the window glass in the window sash. When the outer window glass 4 located on the right side is damaged in the closed state of the window pane in the window sash 1 and so replaced with a new one, the damaged outer window glass 4 is first removed from the glass channel 8 and further removed from the window sash 1, and then the glass channel 8 fitted in the outer rails 21, 31 of the upper frame 2 and the lower frame 3 is pulled out (see FIG. 5A), in which state the spacer 6 is drawn out from the lower frame 3 (see FIG. 5B). In this case, if the spacer 6 is composed of a plurality of divisions along the longitudinal direction of the lower frame 3, the spacer 6 is removed at least over a range opposite to the lower side of the outer window glass 4.

Next, a new window glass 11 is inserted together with the glass channel 8 into the window sash 1 comprising the upper frame 2 and the lower frame 3, over the range in which the spacer 6 has been removed (see FIG. 5C). In this process, the spacer 6 is absent within the range opposite to the lower side of the new window glass 11 in the lower frame 3, so that the new window glass 11 can be moved up and down to an extent of the spacer 6 inside the window sash 1. In addition, the glass channel 8, which is made of a soft resin material such as rubber as described before, can be elastically deformed in the longitudinal direction and thereby easily fitted into the window sash 1 together with the window glass 11.

Also, since the height of the spacer 6 is set generally equal to the depth of the rails 21, 22 of the upper frame 2 as described before, the window glass 11, when moved to a position where its lower side makes contact with the horizontal surface 31c in the outer rail 31 via the glass channel 8, has its upper side located lower than the lower end of the upper frame 2, thus allowing the window glass 11 to be inserted into the window sash 1 without deforming the upper frame 2 and the lower frame 3. After this, the new window glass 11 is moved to the left-side position in the window sash 1 where the window pane is opened (see FIG. 5D), and in a state that the glass channel 8 that has been fitted in the upper frame 2 and the lower frame 3 is pulled out again, the spacer 6 that has been removed from the lower frame 3 is inserted into the lower frame 3 (see FIG. 5E). Further, the glass channel 8 is returned to within the upper frame 2 and the lower frame 3, by which the new window glass 11 can be substituted for the damaged window glass 4 (see FIG. 5F).

As shown above, in the process of replacing the window glass 4 fitted to the window sash 1 with the new window glass 11, once removing the spacers 6 that have been inserted in the rails 31, 32 of the lower frame 3 makes it possible for the window glass 11 to move up and down in the window sash 1, thus eliminating the need of deforming the upper frame 2 and the lower frame 3. Thus, the work of replacing the window glass 4 for the window sash 1 can be very easily achieved while the window sash 1 remains fitted to the vehicle body.

The above example has been described with respect to the work of replacing a damaged window glass 4. Otherwise, in the case where an undamaged window glass 4 is replaced, if the spacer 6 is divided into a plurality of divisions along the longitudinal direction of the lower frame 3, the window glass 4 is once moved leftward and then the spacer 6 is removed from the outer rail 31 of the lower frame 3 over a range opposite to the lower side of the window glass 4 that is located on the right side. After that, the window glass 4 is moved rightward and further moved downward until its lower side makes contact with the horizontal surface 31c of the outer rail 31 via the glass channel 8. As a result of this, the upper side of the window glass 4 is located lower than the lower end of the upper frame 2, so that the window glass 4 can be easily removed without deforming the upper frame 2 and the lower frame 3 while the window sash 1 remains attached to the vehicle body.

The above description has been made on a case where the outer window glass 4 is replaced with a new window glass 11. However, the replacement work of the inner window glass 5 can also be achieved by removing the spacer 6 from the inner rail 32, in the same way as in the outer window glass 4.

Also, the above description has been based on a case where the window glass moves rightward and leftward within the window pane. However, the present invention can be embodied also with a window sash in which the window glass moves upward and downward within the window pane. In this case, the spacer is inserted between either left-side or right-side rail of a frame forming part of the window sash and the window glass. Further, the window glass is not limited to a flat glass which moves within linear rails in the opening/closing operation, and may be a curved-surface glass which moves within partly circular-arc rails in the opening/closing operation.

Further, on one hand, given a constant window-use opening area in the vehicle body, the area of the window pane decreases to an extent of the height of the spacer 6. On the other hand, the spacer 6 has only to be inserted into either one side out of the two sides parallel to the opening/closing direction of the window glass in the window pane defined by the window sash 1. Therefore, by deciding which side of the two sides parallel to the opening/closing direction of the window glass the spacer 6 is inserted into in the window pane, with considerations given to the outside field of view to be ensured via the window pane, decrease in the visibility of the outside due to the decrease in the area of the window pane can be suppressed to a minimum. For example, in the above-described embodiment, with considerations given to passengers' outside field of view of a working-oriented vehicle, the spacer 6 is inserted into the lower side out of the upper and lower two sides of the window pane parallel to the opening/closing direction of the window glasses 4, 5 so that the passengers are prevented from a feeling of pressure due to decrease in the upward field of view.

According to the first aspect of the present invention, when the spacer is removed from between the end face of the window glass and the inner surface of the rail, the movable range of the window glass within the frames along a direction perpendicular to the moving direction can be increased. Therefore, the window glass can be fitted and removed without deforming the frames, so that the workability for the fitting/removal work of the window glass to and from the frames can be improved.

Also, when the spacer is inserted into between the end face of the window glass and the inner surface of the rail, the movable range of the window glass within the frames along a direction perpendicular to the moving direction can be decreased. Therefore, in the opening/closing operation of the window glasses or upon the action of any external force such as vibrations, the window glasses can be securely prevented from falling off from the frames.

According to the second aspect of the present invention, in fitting and removing the spacer, the ratio of the spacer occupying in the part opposite to the end face of the window glass can be decreased. Therefore, the fitting and removing of the spacer can be achieved more easily.

According to the third aspect of the present invention, when the spacer is inserted into between the end face of the window glass and the inner surface of the rail, any move of the window glass in the frame along a direction perpendicular to the moving direction can be securely restricted. Therefore, in the opening/closing operation of the window glass or upon the action of any external force such as vibrations, the window glass can be securely prevented from falling off from the frames. Also, when the spacer is removed from between the end face of the window glass and the inner surface of the rail, the window glass can be moved to an extent of the spacer height within the frame along a direction perpendicular to the moving direction of the window glass. Therefore, the window glass can be easily fitted to and removed from the frame.

What is claimed is:

1. A window sash comprising: a quadrilateral frame in which rails are formed at two sides parallel to each other; two window glasses which move along the rails within the frame; and a spacer which is removably fitted into between at least one end face of each window glass out of its two end faces parallel to each other, and an inner surface of one of the rails facing the end face.

2. A window sash as claimed in claim 1, wherein the spacer is composed of a plurality of portions divided along a longitudinal direction of the rails.

3. A window sash as claimed in claim 1 or 2, wherein with respect to each of the rails formed at two sides of the frame parallel to each other, a distance between faces of the rail facing an end face of each window glass is generally equal to a sum of a distance between the two end faces of the window glass parallel to each other and a height of the spacer.
